(19) United States
(12) Patent Application Publication
(10) Pub. No.: US 2026/0011193 A1
(43) Pub. Date: Jan. 8, 2026

(54) Reusable Reprogrammable E-paper Card for Identity Access Control Applications

(71) Applicant: Elm Company, Riyadh (SA)

(72) Inventors: Najam Us Saqib, Riyadh (SA); Syed Salman Alam, Riyadh (SA); Riad Souissi, Riyadh (SA)

(21) Appl. No.: 19/261,588

(22) Filed: Jul. 7, 2025

Related U.S. Application Data
(60) Provisional application No. 63/668,533, filed on Jul. 8, 2024.

(51) Int. Cl. G07C 9/00; G07C 9/22; G09G 3/34

(52) U.S. Cl. CPC G07C 9/00182; G07C 9/22; G09G 3/344; G07C 2009/00634; G09G 2330/02

(57) ABSTRACT

An access card for accessing a restricted location. The access card comprising at least one display unit configured to display information even when the display unit is unpowered. The access card further comprising a control unit powered by a power source. The control unit being configured to vary the information displayed on the at least one display unit depending on a first predetermined condition being satisfied.

### CROSS-REFERENCE TO RELATED APPLICATIONS

This application claims the benefit of priority to U.S. Provisional Application Ser. No. 63/668,533, filed on Jul. 8, 2024, the contents of which is incorporated herein by reference in its entirety.

### TECHNICAL FIELD

The present disclosure generally relates to the field of access cards for accessing a restricted location. More particularly, some disclosed embodiments involve an access card comprising at least one display unit configured to display information even when the display unit is unpowered.

### BACKGROUND

In secured sites with high personnel turnover, managing access cards presents significant challenges. These cards often need to be issued frequently and for short durations. Most facilities lack the resources to print and program the cards on-site, leading to several problems. For example, outsourcing the printing and programming of access cards creates delays. In addition, it introduces potential security risks, as there is no guarantee that a card cannot be cloned or intercepted during fabrication or delivery.

Even facilities with the capability to print and program cards on-site face issues due to high turnover. The need for a large number of cards, which are typically discarded after a few days or weeks and cannot be reused, results in financial and environmental costs. The frequent issuance of new cards and the disposal of used ones contribute to unnecessary waste and expenses for the facilities.

The disclosed access card is configured to overcome one or more of the problems set forth above and/or other problems of the prior art. Specifically, the following disclosure provides a solution to at least some of the shortcomings associated with single-use access cards in high turnover environments.

### SUMMARY

In accordance with an aspect of the disclosure there is provided an access card for accessing a restricted location, comprising at least one display unit and a control unit. Consistent with some disclosed embodiments, the at least one display unit is configured to display information even when the display unit is unpowered. In some disclosed embodiments, the control unit is powered by a power source, and is configured to vary the information displayed on the at least one display unit depending on a first predetermined condition being satisfied. In this way, the control unit may vary the information displayed on the at least one display unit, depending on a predetermined condition being satisfied. For example, the predetermined condition may relate to a predetermined period of time corresponding to a time period associated with a user's access rights.

In some embodiments, when the access rights of the user change, for example when they expire, the information displayed on the at least one display unit may be erased or modified. This may ensure that the card can no longer be used, improving security. Furthermore, because the information displayed on the at least one display may be varied, this enables the access card to be reprogrammed for another user when required. In this way, a single access card may be reused for other users. For example, the card may be programmed by a remote programming device, via an I/O module.

In some embodiments, the access card may comprise a timer. The timer may be configured to measure a predetermined period of time associated with the first predetermined condition, and upon expiry of the predetermined period of time, the control unit maybe be configured to vary the information displayed on the display unit.

In some embodiments, the access card may also comprise a wireless communication module enabling communication between the access card and a wireless terminal located remotely from the access card. For example, the wireless communication module may comprise an NFC or RFID chip, enabling wireless communication between the access card and an NFC or RFID-enabled remote terminal.

In some embodiments, the terminal may control access to the restricted location. The wireless communication module may be disabled depending on a second predetermined condition being satisfied. For example, the second predetermined condition may relate to a predetermined amount of time, on or after expiry of which the wireless functionality of the wireless communication module of the access card may be disabled. In some exemplary embodiments, the second predetermined condition and the first predetermined condition may be the same condition. For example, where the first and second predetermined condition relate to a predetermined time period associated with a period of time for which a user has been authorized to access the secure location, on expiry of the predetermined time period, the wireless functionality of the card may be disabled, whilst simultaneously the information displayed on the display unit is varied to indicate that access has expired.

In some embodiments, the at least one display unit may comprise an electronic paper (e-paper) display, and the at least one display unit may comprise a color display unit or a greyscale display unit. E-paper displays mimic the appearance of ink on paper and thus offer high readability —in various lighting conditions. E-paper displays also offer low power consumption when changing what is being displayed, making them a good solution for battery-powered devices.

In some embodiments, the information displayed on the access card may comprise information about the user, for example, its name or picture, or information about the user's access rights. For example, the access card may display the names, numbers, denominations or representations of the locations a user of the access card is authorized to access. This may enable a security guard to rapidly assess whether the user should be granted access to a restricted location. The card may also display a QR code for example. The QR code may also comprise information about the user or its access rights, only in an encrypted format.

In some embodiments, the access card may also comprise a tracking device configured to indicate the location of the access card. For example, the tracking device may comprise a Bluetooth Low Energy module configured to communicate with one or more fixed remotely located Bluetooth gateways. By communicating with gateways at known locations, the card's location may be accurately deduced. For example, the tracking of the card, coupled with a map of the secure location, may be visualized by the user via a user application and may enable the user to navigate the secure location without getting lost. The user application associated with the card tracking may also enable the user to view on the map the restricted location to which the user is authorized or not authorized to access. Card tracking may also enable a security team to monitor the location of users at any time, to ensure that no user is trespassing. As used herein, a Bluetooth Low Energy (BLE) module may also comprise a BLE enabled microcontroller or BLE enabled System on Chip (SoC).

In some embodiments, the access card may also comprise an audio unit that may be configured to emit an audible signal when the access card is located in a location it is not authorized to be in, thus alerting the user and anyone else in the vicinity.

In some embodiments, the method of issuing the access card is also disclosed.

### BRIEF DESCRIPTION OF THE DRAWINGS

The accompanying drawings, which are incorporated in and constitute a part of this specification, illustrate some disclosed embodiments and, together with the description, serve to explain the disclosed embodiments. The particulars shown are by way of example and for purposes of illustrative discussion of embodiments of the present disclosure. The description taken with the drawings makes apparent to those skilled in the art how embodiments of the present disclosure may be practiced.

FIG. 1 is a schematic diagram illustrating the functional components of an access card in accordance with embodiments of the disclosure.

FIG. 2 is a schematic diagram illustrating the functional components of an access card in accordance with a further embodiment of the disclosure.

FIG. 3 is a process flow chart illustrating a method of using the access card to access a restricted location in accordance with embodiments of the disclosure.

FIG. 4 is a process flow chart illustrating a method of using the card depending on the security system of the restricted location, in accordance with embodiments of the disclosure.

FIG. 5 is a process flow chart illustrating an exemplary method of using the access card when the restricted location is controlled through visual inspection of the card by a security guard, in accordance with embodiments of the disclosure.

FIG. 6 is a process flow chart illustrating an exemplary method of using the access card when the restricted location is controlled via wireless communication with a wireless terminal, in accordance with embodiments of the disclosure.

FIG. 7 is a process flow chart illustrating an exemplary method of using the access card when access to the restricted location is controlled using a QR code, in accordance with embodiments of the disclosure.

FIG. 8 is a process flow chart illustrating an exemplary method of using the access card when access to the restricted location is controlled through on-site location tracking in accordance with embodiments of the disclosure.

FIG. 9 is a process flow chart illustrating a method of issuing the access card, in accordance with embodiments of the disclosure.

FIG. 10 is a process flow chart illustrating a method of issuing the access card depending on the type of security verification used in the restricted location, in accordance with embodiments of the disclosure.

FIG. 11 is a process flow chart illustrating an exemplary method of issuing the access card when the security verification is a visual inspection of the card, in accordance with embodiments of the disclosure.

FIG. 12 is a process flow chart illustrating an exemplary method of issuing the access card when the security verification comprises use of wireless communication between the card and a wireless terminal, in accordance with embodiments of the disclosure.

FIG. 13 is a process flow chart illustrating an exemplary method of issuing the access card when the required security verification is a QR code.

FIG. 14 is a process flow chart illustrating an exemplary method of issuing the access card when the restricted location is controlled through on-site location tracking in accordance with embodiments of the disclosure.

FIG. 15 is a process flow chart illustrating a method of configuring the access card using software running on a remote programming device such as a computer.

FIG. 16 is a schematic representation of the format of data exchanged between the terminal running the software and the card's control unit.

FIG. 17 is a process flow chart illustrating a method of transmitting the information packets of FIG. 16 from the programming software to the card's control unit.

FIG. 18 is a process flow chart illustrating a method of programming the access card;

FIG. 19 is a screenshot of an example graphical user interface of the programming software used to configure the access card.

FIG. 20 is a picture of the components of the access card, in accordance with an embodiment.

FIG. 21 is a picture of the enclosure with pinholes, and mounted pins, in accordance with an embodiment.

FIG. 22 is a picture of a printed circuit board (PCB) comprising the functional components of the access card, in accordance with an embodiment.

FIG. 23 is a picture of a display unit mounted to a front section of the enclosure of the access card, and comprising an NFC or RFID chip stuck to the display unit.

FIG. 24 is a picture of the PCB of FIG. 23 aligned with the pins of the enclosure of FIG. 22.

FIG. 25 is a picture of a color display unit and back plate of an access card.

FIG. 26 is a picture of an access card comprising two display units being assembled.

FIG. 27 is a picture of a greyscale screen being connected to the PCB and mounted in the card's enclosure.

FIG. 28 is a picture of the back of an access card having only one display unit, and a picture of an ultrathin battery.

FIG. 29 is a front picture of the access card after complete assembly, and a perspective view picture of the card on a docking station.

### DETAILED DESCRIPTION

Specific embodiments of the disclosure will now be described with reference to the appended figures.

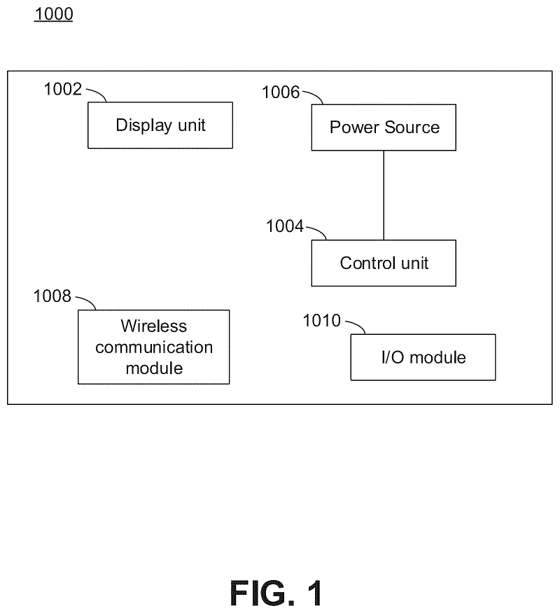

FIG. 1 is a schematic diagram illustrating the functional components of an access card 1000 for accessing a restricted location, in accordance with an embodiment. The access card 1000 may comprise at least one display unit 1002 configured to display information even when the display unit is unpowered. This enables the display to retain and continue displaying its visual information whilst unpowered, when being used. The access card 1000 may also comprise a control unit 1004 powered by a power source 1006. The control unit may be configured to vary the information displayed on the at least one display unit 1002 depending on a first predetermined condition being satisfied.

In accordance with some exemplary embodiments, the first predetermined condition may comprise expiry of a predetermined time period for accessing the restricted location. The first predetermined condition may comprise a change of the access rights of the user. Other predetermined conditions are also envisaged. It is to be appreciated that the specific details of the predetermined condition are immaterial, suffice it that once the predetermined condition is satisfied, the control unit 1004 is configured to automatically vary the information displayed on the at least one display unit 1002, without the access card 1000 requiring any further external prompt, or external reprogramming, for example from a remote processing terminal.

In accordance with some embodiments, the control unit 1004 may comprise a timer, and the first predetermined condition may comprise expiry of a predetermined time period measured by the timer. In such embodiments, the control unit may be configured to vary the information displayed on the at least one display unit on or after expiry of the predetermined time period.

In accordance with some embodiments, the access card 1000 may comprise a wireless communication module 1008. In some embodiments, wireless communication module 1008 may be comprised in control unit 1004. The wireless communication module 1008 may enable a terminal located remotely from the access card to wirelessly communicate with the access card, and the control unit may be triggered to vary the information displayed on the at least one display unit based on wireless communication with the terminal. In such embodiments, the first predetermined condition may be the establishment of the wireless communication between the access card and the wireless terminal. The wireless communication module may comprise any one or more of a NFC chip, and/or an RFID chip configured to communicate with a NFC or RFID enabled terminal. The NFC or RFID enabled terminal may comprise a turnstile, and access through the turnstile may be controlled via the wireless functionality of the terminal, to control access to the restricted location.

For example, a malicious user may try to access a restricted location, whose access is controlled by a wirelessly enabled turnstile, after the expiry of its access rights. While establishing a wireless connection between the access card and the wireless terminal, a handshake may be exchanged between the card and the terminal, triggering the card's control unit, configured to modify the information displayed.

According to some embodiments, the control unit 1004 may be configured to disable the NFC or RFID chip depending on a second predetermined condition being satisfied. The first and second predetermined conditions may relate to different conditions. For example, in this way whilst the first predetermined condition being satisfied enables the control unit to vary the information displayed on the display of the access card, the second predetermined condition may be used to disable or enable the access card's wireless functionality. In some embodiments, the first and the second predetermined condition may relate to the same condition. For example, both conditions may relate to the period of time for which the user is authorized to access the secure location. One this period expires, the control unit may amend the information displayed on the display unit of the card, to indicate that the user's access rights have expired, whilst simultaneously the wireless functionality of the access card may be disabled, thus preventing access via any wireless terminal controlling access to the secured location.

In some embodiments, the at least one display unit 1002 may comprise an electronic paper display. The at least one display unit 1002 may also be a color display unit or a greyscale display unit. An electronic paper display unit, commonly referred to as an e-paper display is a relatively economical display technology, which retains the information displayed on it even when the display is not powered. E-paper display, is a type of digital display technology that mimics the appearance of ink on paper. It typically consists of microcapsules containing charged particles suspended in a liquid, which respond to electrical charges to produce text and images. E-paper displays offer low power consumption, high readability in various lighting conditions, and a paper-like viewing experience.

The type of information displayed on the access card may be determined by the specific use of the card. However, it is envisaged that the information displayed on the card may include the name of a card user, a picture of a card user, or any other unique identifier associated with the authorized user the access card has been issued to. The information displayed on the card may include any one or more of: the names, numbers, denominations or representations of the locations a user of the access card is authorized to access.

In some embodiments, the information displayed on the card may also include a QR code. In such embodiments, the displayed QR code may comprise encrypted information about the authorized user, such as the user's name.

The access card may comprise an I/O module 1010 enabling communication with a remote programming device. For example, via a data cable connecting the remote programming device to the access card via the I/O module. The connection between the I/O module and the remote programming device may also be enabled by a docking station wired to the remote programming device.

The control unit 1004 may comprise a processor, a working memory or any other electrical circuitry. For example, the access card may comprise a memory unit referred to as a local memory or RAM.

According to some example embodiments, the access card may comprise a tracking device configured to indicate a location of the access card. In such embodiments, the tracking device may comprise a Bluetooth Low Energy module configured to communicate with one or more fixed remotely located Bluetooth gateways located throughout the restricted location that the access card provides access to.

In accordance with some embodiments, the tracking of the access card may be operated via Wi-Fi, Magnetic field detection, Near Field Communication (NFC) or ultra-wideband.

The card's Bluetooth Low Emission module may also act as a beacon, communicating with fixed remotely located beacons. Upon establishment of wireless communication between the card's beacon and one or more fixed location beacons, the card's control unit may determine from the location of the fixed location beacons if the access card is located in an authorized or unauthorized location. Accordingly, the user may be alerted when entering an unauthorized location.

In some embodiments, the access card may comprise an audio unit configured to emit an audible signal when the access card is located in a location it is not authorized to be in. For example, should the user of the access card inadvertently enter a restricted area they are not authorized to enter, based on a determination of the location of the access card, the access card may emit an audible alert, notifying both the user and those nearby that the user is in an unauthorized area.

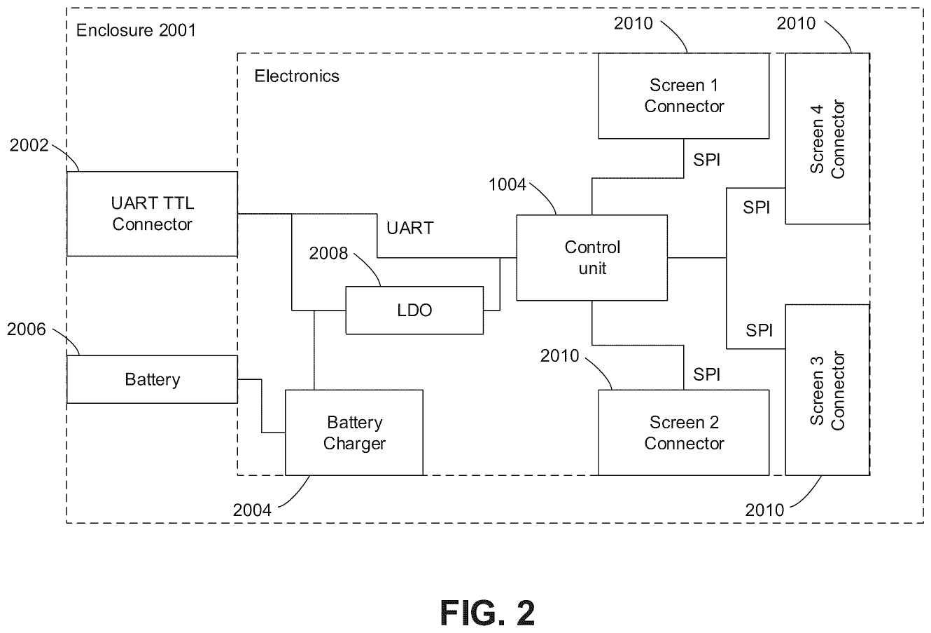

In accordance with embodiments of the disclosure, the functional components of the access card may be configured on a printed circuit board (PCB). This is illustrated in FIG. 2, which is a functional system diagram illustrating the functional components that may be comprised on a PCB, in accordance with further embodiments of the disclosure.

The access card may comprise a battery charger 2004 and a battery 2006. In some embodiments, the battery may be a rechargeable ultrathin LiPo battery. Ultrathin batteries are 0.4 mm to 1 mm in thickness and don't need a lot of volume to store charge, which is sufficient for device operation as the cards are given to the visitor for a day to a week. When the e-paper cards are not given, they are placed in a storage box where they have the power to recharge and remain fully charged. The battery 2006 may be the power source 1006 of FIG. 1.

The access card may also comprise a UART TTL connector interface 2002. The interface may comprise five gold plated pins embedded into the enclosure for power and communication. In accordance with some embodiments the interface may provide five volts and may be internally connected to the battery charger of the card in such a way that if the card is flipped, there will be reverse polarity protection. In such embodiments, the battery 2006 of the access card may be charged when the card is connected to the remote programming device. The remaining pins may be connected to the control unit's TTL UART interface. According to TTL UART electrical specifications, these don't need reverse polarity protection. TTL UART is a serial communication interface used in embedded devices. It stands for Transistor-Transistor Logic Universal Asynchronous Receiver/Transmitter. It is a low-voltage alternative to standard UART, where there is no strict requirement for noise immunity. Standard UART is usually used in high-noise environments where the cable lengths are tens of meters. Our device is 10 cm long with an additional 5 cm of TTL UART wiring in our programming docking station, so TTL UART is suitable for the present use case as it can work up to 30 cm at low baud rates. The I/O interface 1010 of FIG. 1 may be part of the UART TTL connector 2002.

The access card may also comprise a low dropout regulator (LDO) 2008. The LDO converter may be designed to supply low voltage to the control unit and e-paper screens when the card is connected to the remote programming device, for which 5 volts is standard. The components illustrated in FIG. 2 may be comprised on a printed circuit board (PCB). When the access card is not connected to the remote programming device, the battery 2006 may supply power to the LDO.

The control unit 1004 may be configured on the PCB. The PCB may comprise one or more screen connectors 2010, each connector enabling a display unit to be connected to the PCB. Different screen connectors may be used for different types of display. For example, Screen 1 connector and Screen 2 connector can be used for color e-paper displays, while Screen 3 connector and Screen 4 connector may be suitable for connecting to a grayscale e-paper display. It should be appreciated that any combination of screen types is possible, and the card may comprise more than one display. For example, the access card may comprise two screens, one provided on each face of the access card.

The control unit and the one or more screen connectors may be connected via a Serial Peripheral Interface (SPI).

According to some example embodiments, the access card may also comprise an LED.

All the components illustrated in the figures may be enclosed in an enclosure, such as a protective casing. For example, the PCB of FIG. 2 may be housed in the enclosure. Where the access card comprises two screens, one on each face of the access card, the enclosure may be designed to hold the front and back screens in place, as well as the UART TTL connector 2002.

Different methods for using the afore-described access card are envisaged. The following description describes some different ways in which the card may be used, including different ways in which the card may be configured.

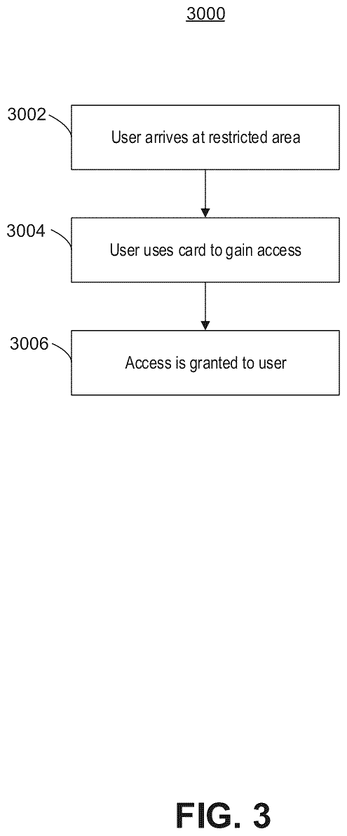

FIG. 3 is an exemplary flow diagram illustrating a method 3000 of how the access card may be used to access a restricted location. The method commences at step 3002, when the user arrives at the restricted location. At step 3004, the user uses their access card to access the restricted location. Access to the restricted location may be controlled through visual inspection of the card by a security guard, wireless communication between the card and a wireless terminal, use of a QR code, or on-site location tracking, or any of the other aforementioned verification methods.

Provided that the verification check is successful, at step 3006, the user is granted access to the restricted location.

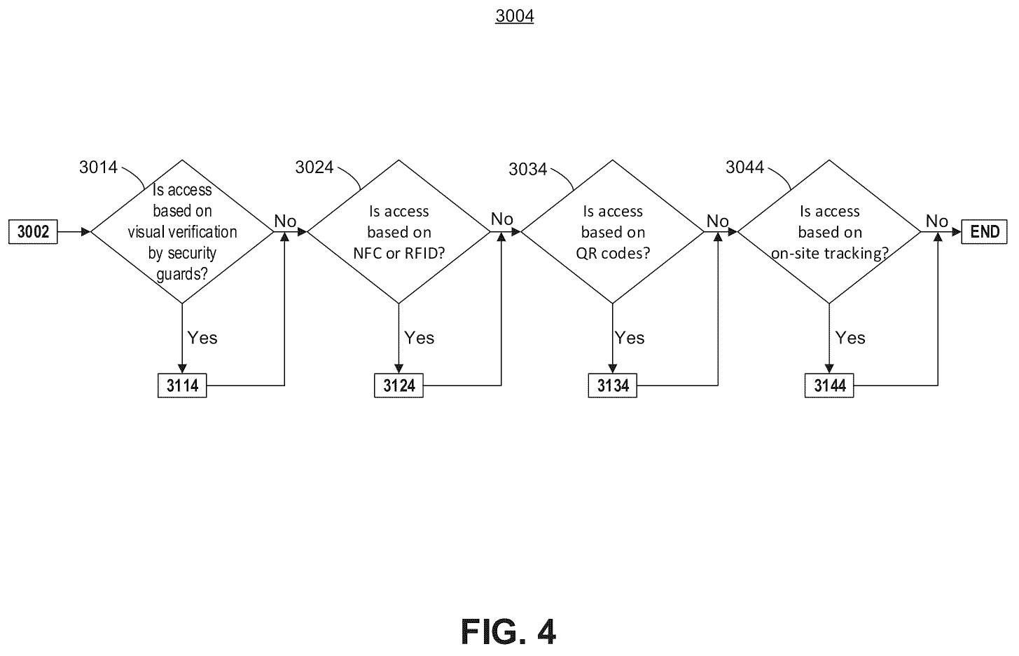

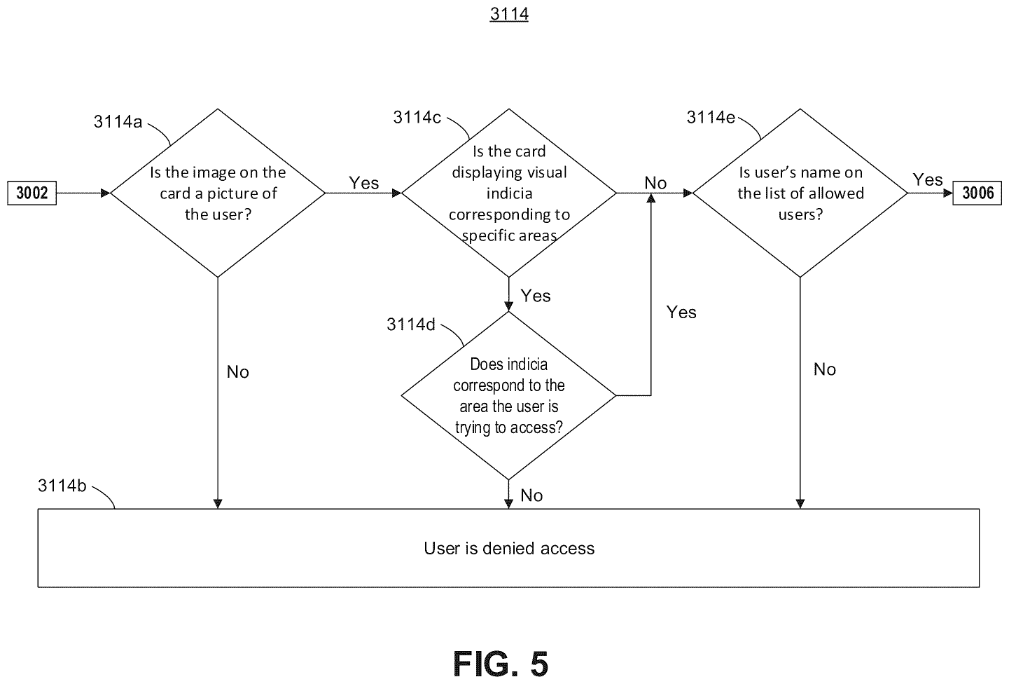

FIG. 4 provides further details associated with step 3004. At step 3014, following completion of step 3002, the method determines whether the access to the restricted location is based on visual verification of the access card by a security guard. If it is, the method proceeds to step 3114, detailed in FIG. 5, and subsequently moves to step 3024. If it is not, the method advances to step 3024.

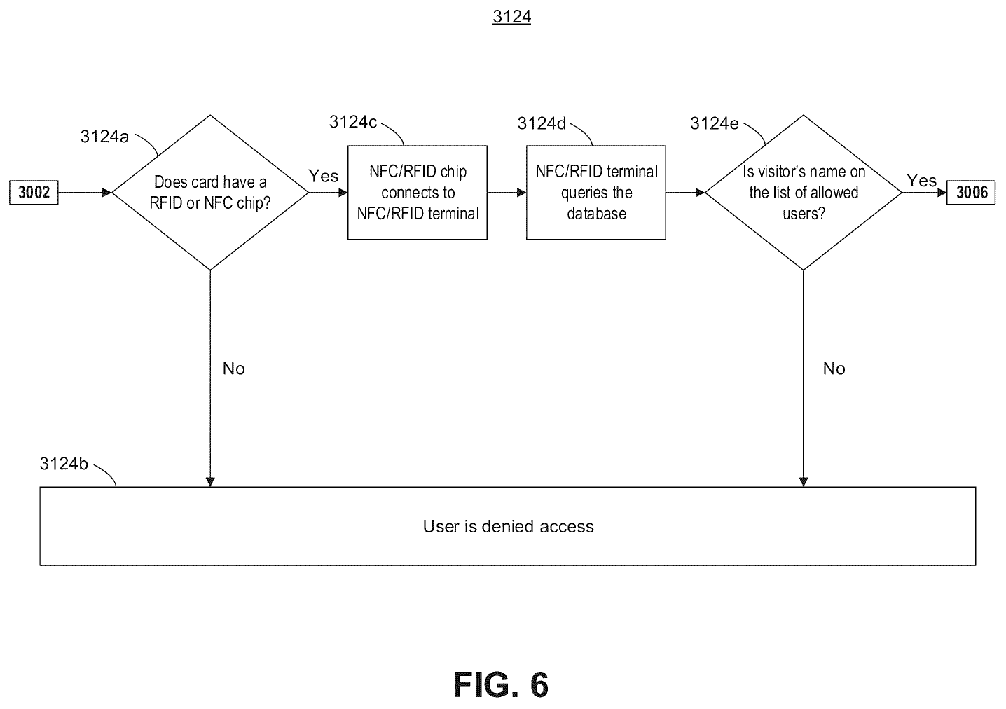

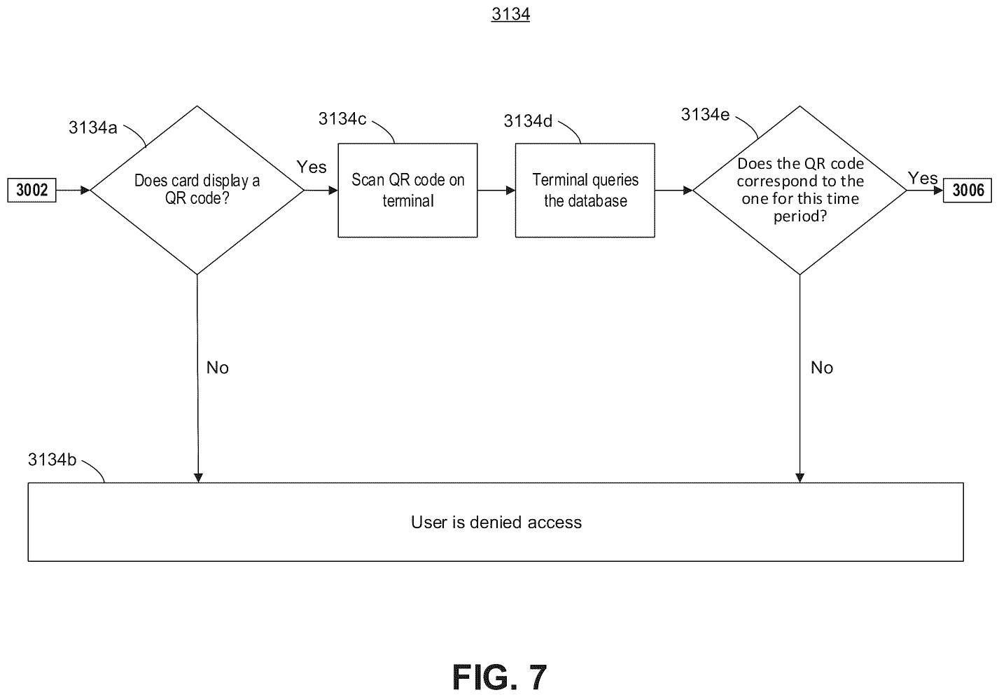

At step 3024, the method evaluates whether the security of the secured location relies on wireless communication between the access card and a wireless station. If it does, the method proceeds to step 3124, as detailed in FIG. 6, and subsequently moves to step 3034. If it does not, the method directly advances to step 3034. At step 3034, the method evaluates whether the security of the secured location relies on QR codes to be scanned by a scanning device. If it does, the method proceeds to step 3134, detailed in FIG. 7, and subsequently moves to step 3044. If it does not, the method directly advances to step 3044.

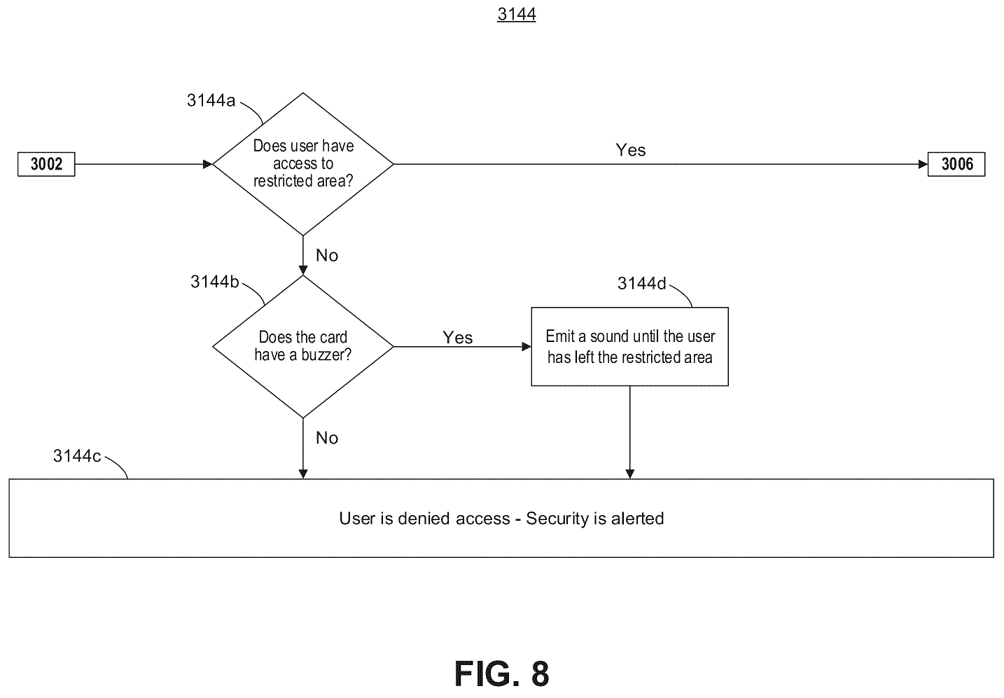

At step 3044, the method evaluates whether the security of the secured location relies on on-site tracking. If it does, the method proceeds to step 3144, as detailed in FIG. 8, and the method ends. If it does not, the method ends directly.

It is to be appreciated that the order of the steps described in FIG. 4 visual is immaterial; the steps can be performed in any sequence without affecting the overall method.

FIG. 5 is a flow diagram providing further details of method step 3114. At step 3114a, following completion of step 3002, the security guard assesses if there is a picture on the card, and whether the picture on the card is a picture of the user. If it is not, the method proceeds to step 3114b. If it is, the method moves to step 3114c. In some example embodiments, the picture on the card may not match the user because the card was issued to another individual. In other embodiments, the discrepancy may be due to an error during the card issuance method. In yet some other embodiments, the user's visual features (such as hair, beard, glasses, or makeup) may have changed between the time the picture was taken and when the user attempts to access the secured location. In such cases, the security guard may mistakenly believe the picture on the card does not belong to the user. In all these scenarios, the user may be referred to the card issuance team to resolve the issue. At step 3114b, the user is denied access to the secured location.

At step 3114c, the security guard assesses whether the card is displaying visual indicia corresponding to specific areas of the restricted location. If it does, the method moves to step 3114d, and subsequently advances to step 3114e. If it does not, the method advances to step 3114e.

At step 3114d, the security guard assesses whether the visual indicia correspond to the location the user is trying to access. If it does not, the method moves to step 3114b, and access is denied. If it does, the method advances to step 3114b.

At step 3114e, the security guard assesses whether the user's name is on the list of allowed users. If it is, the method moves to step 3006, and access is granted. If it is not, the method moves to step 3114b and access is denied.

In some embodiments, access may be granted solely on the basis of a visual confirmation of the user's identity carried out based on visual indicia displayed on the card.

FIG. 6 is a flow diagram providing further details of step 3124. At step 3124a, the method evaluates if the access card is equipped with a RFID or NFC chip. If it is not, the method moves to step 3124b, and the user is denied access to the secure location. If it does, the method proceeds to step 3124c.

At step 3124c, the card may wirelessly communicate with a wireless terminal using radio frequency communication to share the user's verification information with the terminal. The shared information may include the name of the user. In some other embodiments, the shared information may include the user's access rights.

At step 3124d, the NFC/RFID terminal queries a security database. At step 3124e, the method determines whether the user's name is comprised in the list of authorised users. If it is, the method moves to step 3006, and access is granted. If not, the method moves to step 3124b and access is denied.

FIG. 7 is a flow diagram providing further details of step 3134. At step 3134a, following completion of step 3002, it is determined if the card comprises a displayed QR code. If it does not, the method advances to step 3134b. If it does, the method proceeds to step 3134c. At step 3134b, the user is denied access to the secured location. At step 3134c, the user scans the QR code on the terminal. At step 3134d, the terminal queries the database of the security system to determine if the scanned QR code is valid.

In accordance with some embodiments, the displayed QR code may comprise encrypted information about the user. The encrypted information may include the user's name. Accordingly, the terminal may communicate with the security system database to query whether the user's name is comprised in a list of allowed users.

At step 3134e, the terminal evaluates whether the scanned QR code allows access to the secured location at the time of scanning. If it does, the method proceeds to step 3006, and access is granted to the user. If it does not, the method proceeds to step 3134b and access is denied.

FIG. 8 is a flow diagram providing further details of step 3144. At step 3144, following completion of step 3002, it is determined whether the user has access to the restricted location. For example, while the user approaches the restricted location, the security database may be queried to determine if the user's name is on the access list. If they do, the method proceeds to step 3006, and access is granted to the user. If they don't, the method proceeds to step 3144b. At step 3144b, it is determined if the access comprises an audio unit, such as a buzzer. If it does not, the method proceeds to step 3144c. If it does, the method proceeds to step 3144d. At step 3144c, the user is denied access to the secured location and the security team may be alerted.

At step 3144d, the card emits an audible alert warning the user and anyone else in its vicinity that they entered a restricted area they aren't authorized to access. The method subsequently proceeds to step 3144c.

Determining whether the user has access to the restricted location at step 3002 may also be enabled by establishing a communication between the card's beacon and fixed remotely located beacons.

In accordance with some embodiments, the on-site location tracking feature of the access card may be used beyond solely granting access to a restricted location. For example, a tracking application may be used to track the location of the access card, and by association the location of the associated user. The access card may for example change the background of the display to indicate that the user is entering an unauthorized location. The location of the card may also be monitored by the security team to ensure that no one is trespassing.

It should be appreciated that all the steps of this method may be automated and executed on a remote programming device at the location where the card is issued.

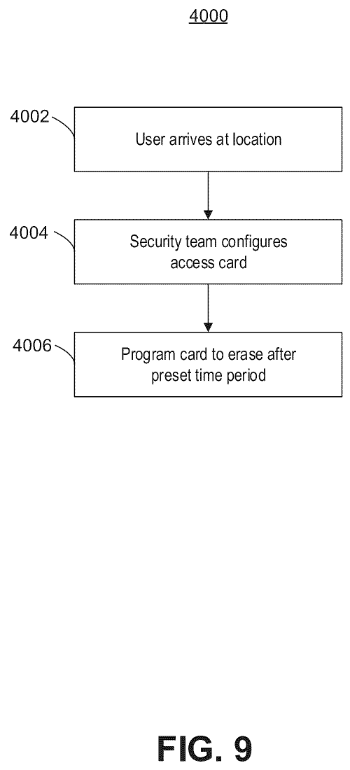

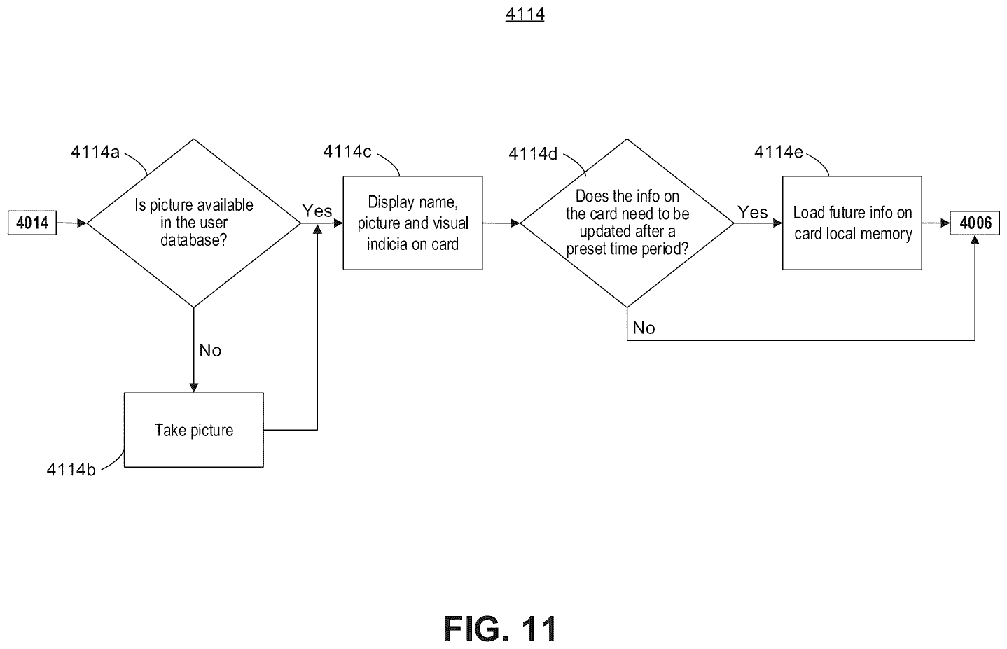

FIG. 9 is an exemplary flow diagram illustrating a method 4000 for issuing the card. The method commences at step 4002, when the user arrives at the restricted location they wish to access. The restricted location may be a building. In some other embodiments the secure location may be a construction site, or any other location where it is necessary to restrict access to designated persons. At step 4004, the security team, or other responsible person for controlling access to the secured location, configure the access card. Further details of how the card may be configured is detailed in FIG. 11.

At step 4006, the card is programmed to automatically erase and/or deactivate after a predefined time period. In some embodiments, this period may correspond to a time period for which the user has been authorized to access the secured location, after or on expiry of which, the user's access rights may be terminated. In some embodiments, the card may be programmed to erase and/or deactivate based on a change in the user's access privileges.

According to some example embodiments, the access card may be re-used after a user's access rights have expired, and the user returns the card to the security team. In such embodiments, the access card is re-programmed for a new user, using the same method as disclosed in FIG. 9.

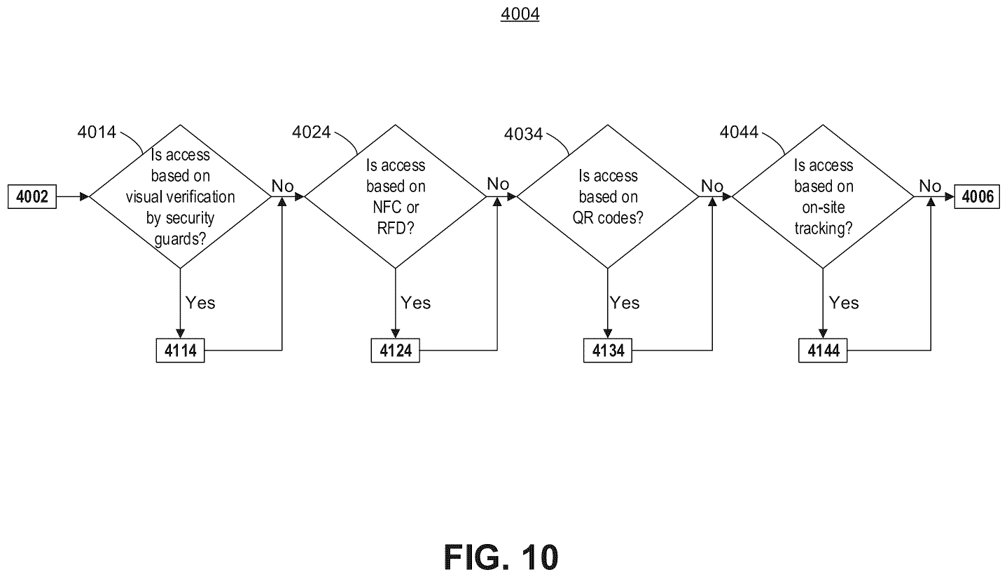

FIG. 10 is a flow diagram providing further detail of how the access card may be configured, and in particular provides further details regarding step 4004 of FIG. 9.

At step 4014, following the completion of step 4002, it is determined whether the security of the secured location relies on a visual verification of the access card. If it does, then the method proceeds to step 4114, of FIG. 11, where a visual indicia, such as a picture of the user is obtained. The method subsequently continues to step 4024. Alternatively, if visual verification is not required, then the method proceeds directly to step 2024.

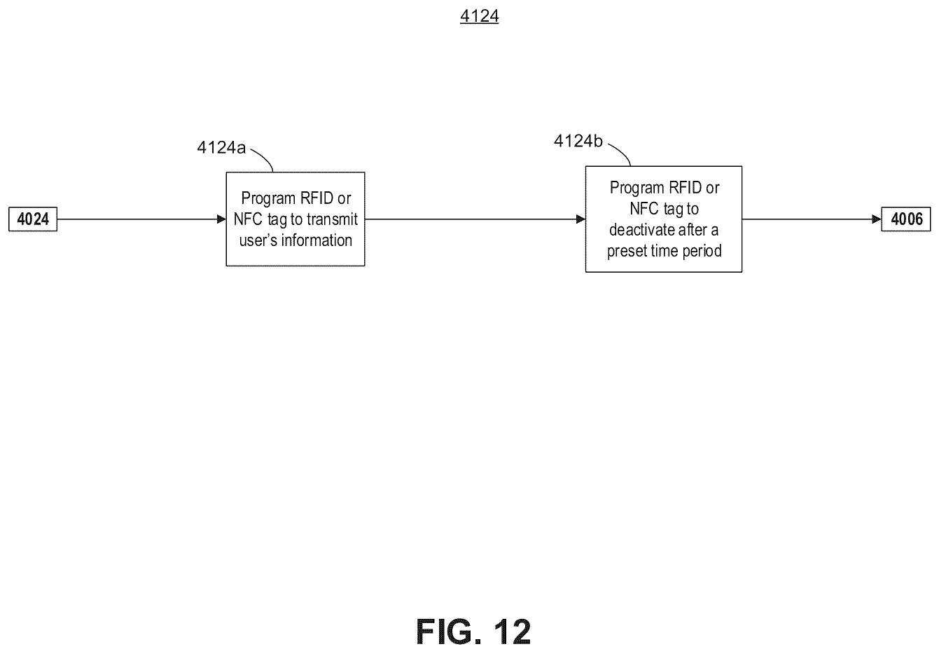

At step 4024, it is determined if wireless communication is required, between the access card and a wireless station, to control access to the secured location. If it does, the method proceeds to step 4124, detailed in FIG. 12, and subsequently moves to step 4034. Alternatively, if wireless communication is not required, the method proceeds directly to step 4034.

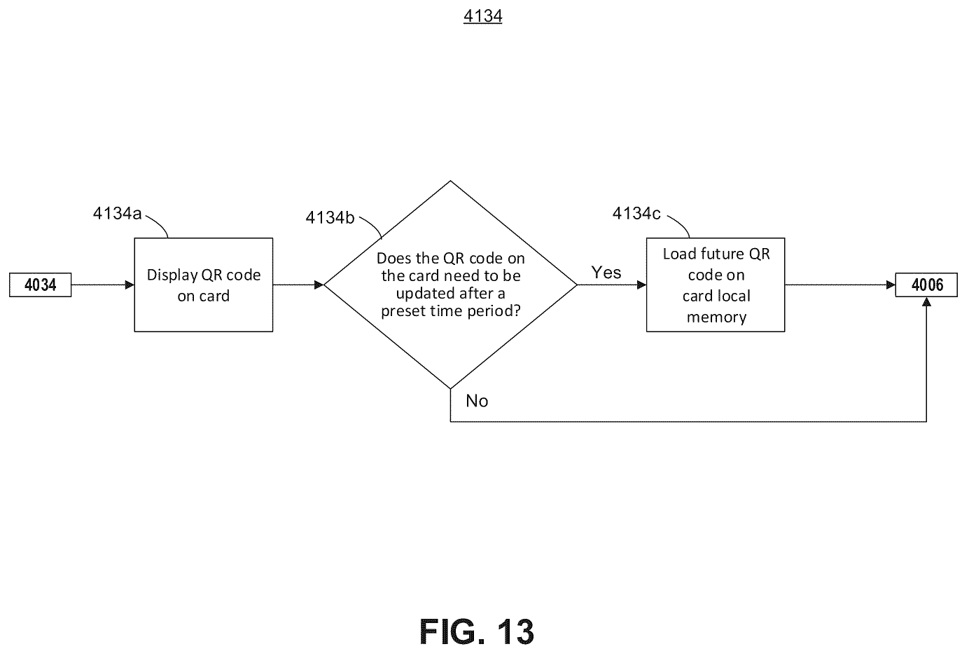

At step 4034, it is determined if a QR code is required, to enable the access card to be scanned by a scanning device. If a QR code is required, the method proceeds to step 4134, detailed in FIG. 13, following which the method proceeds to step 4044. Alternatively, if a QR code is not required, the method proceeds directly to step 4044.

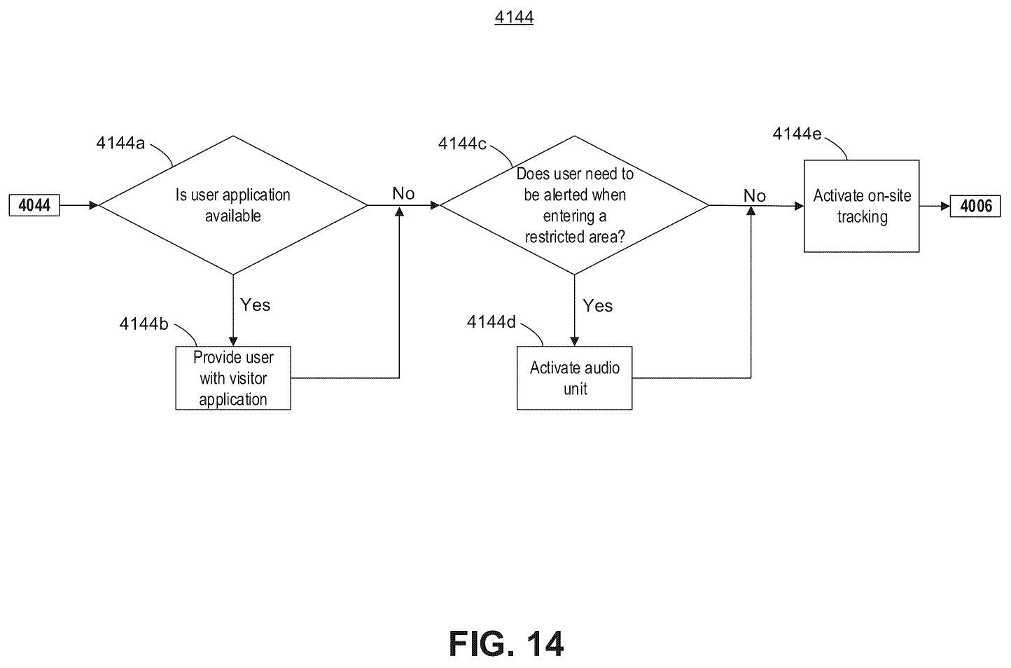

At step 4044, it is determined if on-site tracking of the location of the access card is required. On-site tracking may enable the location of the access card to be monitored. If on-site tracking is required, the method proceeds to step 4144, detailed in FIG. 14, and subsequently proceeds to step 4006. If on-site tracking is not required, the method proceeds directly to step 4006.

It is to be appreciated that the order of the steps described in FIG. 10 is immaterial; the steps can be performed in any sequence without affecting the overall method. Furthermore, it is also to be appreciated that not all steps are required. Only the steps associated with the security features adopted for the given location may be implemented. For example, in embodiments where only visual verification is required, steps 4024 through 4044 may be omitted, and instead the method proceeds to step 4006.

It is to be appreciated that the security of the secured location may rely on multiple verification methods. In some embodiments, visual verification of the access card may be combined with QR code-based security. In other embodiments, all four types of security measures may be utilized by the secured location.

FIG. 11 provides further details of the method steps that may be comprised in step 4114. At step 4114a, once it has been determined that visual verification is required, at step 4014, the method determines whether a picture of the user is already available. For example, this may comprise determining if the user's picture is comprised in a security database. If a picture is available, the method proceeds to step 4114c. If a picture is not available, then a picture of the user is captured at step 4114b. The method subsequently advances to step 4114c.

In some example embodiments, the remote programming device may take a picture of the user. In such embodiments, the programming software may be further programmed to remove the background of the picture using AI.

In some example embodiments, the programming software may use dithering on the picture, wherein dithering is a method of mapping a full-color image to a limited color palette associated with the color display retaining screen.

At step 4114c, visual information associated with the user may be displayed on the display of the access card. The displayed information may include a picture of a user, the name of the user, whether the user is a visitor or a worker, the name of the company the user is visiting or working for, and/or the dates corresponding to the access period of the user. The displayed information may also include visual indicia related to the user's access rights. These visual indicia can be of any shape, color, or size. They may include the names, numbers, or denominations of the areas the user is permitted to access. In some embodiments, where the access card comprises a color display, the background color of the display may indicate the user's level of access.

At step 4114d, it is determined if the visual information displayed on the on the card needs to be updated after a preset time period. In some embodiments, the user's access rights may need to change while the access card is in use. In such cases, the information displayed on the card may be updated to reflect the change in the user's access rights. If the information needs to be updated after a preset time period, the method proceeds to step 4114e. If the information does not need to be updated after a preset time period, the method moves to step 4006. At step 4114e, the new information the card is to be updated with after the preset time period, is uploaded to the card. This information may be stored on the card's local memory. The method then proceeds to step 2006.

FIG. 12 is a flow diagram providing further details of the method steps associated with step 4124, when it is determined that NFC or RFID communication is required. In such embodiments, the access card may comprise a wireless communications module, which may comprise an RFID or NFC chip. At step 4124a, the RFID or NFC chip comprised in the access card may be programmed to transmit the user's information when interrogated by a RFID or NFC terminal. At step 4124b, the RFID or NFC chip, as the case may be, may be programmed to deactivate after a preset time period. In some embodiments, this preset time period may correspond to the duration for which the user has been granted access rights. In this way the access card may be configured to automatically cease enabling the access card to access the restricted location on expiry of the preset time period. In other embodiments, it aligns with potential changes in the user's access privileges.

FIG. 13 provides further details of the method steps comprised in step 4134. At step 4134a, the QR code is displayed on the display detaining screen. In accordance with some exemplary embodiments, the QR code may be displayed on a display located on the front of the access card. The QR code may be displayed alongside any visual indicia to be displayed on the display of the card. In some other embodiments, the QR code may be displayed on a display located on the back of the card.

At step 4134b, the method assesses whether the QR code needs to be updated after a preset time period. If the QR code needs to be updated after a preset time period, the method moves to step 4134c. If the QR code does not need to be updated, the method proceeds directly to step 4006.

Where access to the secured location requires QR codes, the QR code may be regularly updated, to improve security. If the QR code were to remain the same for an extended period, a malicious user could copy the QR code and re-use it to access the secure location even when not authorised. Therefore, regularly updating the QR code improves security. Alternatively, or additionally, the update of the QR code displayed on the card may be based on a location of the card. For example, this could prevent a malicious user copying the QR code and sharing it with another malicious user located at a different site location (e.g., where the QR code would be scanned by a different security guard).

At step 4134c, the information to be updated after a preset time period, here the QR code, is uploaded on the card's local memory. The method then proceeds to step 4006.

FIG. 14 is a flow diagram detailing the method associated with step 4144.

At step 4144a, following the completion of step 4044, the method assesses if a visitor application is available. If a user application is available, the method moves to step 4144b, and subsequently advances to step 4144c. If a user application is not available, the method proceeds to step 4144c. At step 4144b, the user is provided with the user application.

In some embodiments, the user can use the user application to be guided throughout the venue to avoid getting lost. Similarly, the user may use the dedicated application to monitor and navigate to those areas where they are authorized to access, and avoid those areas where they do not have authorization to access.

At step 4144c, the method assesses whether the user needs to be alerted upon entering a restricted area. If they do, the method advances to step 4144d, and subsequently proceeds to step 4144e. If they don't the method moves directly to step 4144e.

At step 4144d, the audio unit of the card is activated. The audio unit will be responsible for giving the audible alert to the user in case of trespassing.

At step 4144e, the on-site tracking is activated.

In some example embodiments, the tracking of the access card may be operated via Bluetooth gateways. Fixed Bluetooth gateways may be arranged in the secured location, while the card itself may act as an emitter, emitting radio signals at regular intervals. Upon receiving these signals, the fixed gateways, connected to a central server, can track the card's location.

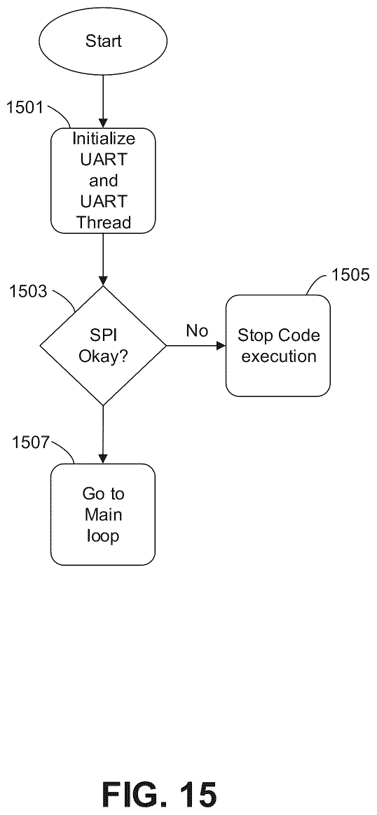

FIGS. 15 to 18 detail the steps comprised in a method for programming the access card. During card issuance or card updating, the card may be connected to a docking station. The docking station physically connects to the card through wired communication, allowed by communication pins on the access card. The docking station may also be connected to a computer via wired communication. The access card and the docking station may also comprise magnets to enable solid contact between the access card and the docking station. For example, the magnets may be neodymium magnets.

The computer in communication with the access card, through the docking station, runs a programming software, allowing information to be exchanged between the computer and the access card's control unit.

The communication between the programming software and the access card's control unit may be completed using a Universal Asynchronous Receiver-Transmitter (UART).

The docking station may be designed with two main components, namely a USB to TTL-UART converter and a magnetic pogo spring-loaded connector for programming devices. The USB to TTL-UART converter provides a PC interface, and the magnetic connector may be connected to the converter using wires. It also provides polarity protection to devices (in case the card is put the wrong way on the docking station).

FIG. 15 is a flow diagram illustrating how communication may be established between the programming software running on a computer (terminal), and the card docked on the docking station.

The method begins at step 1501, where the programming software initializes the UART interface. At step 1503, the programming software verifies the proper functionality of the SPI interface. If the SPI interface functions properly, the programming software moves to step 1507. If it does not, the programming software advances to step 1505.

At step 1505, the programming software stops the execution of the code.

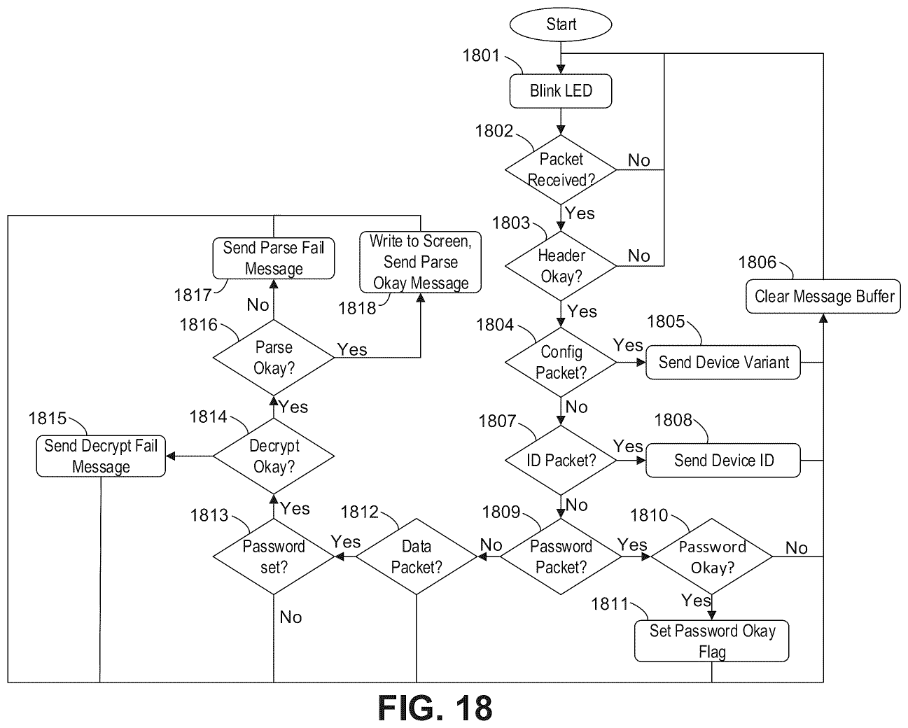

At step 1507, the programming software starts the main loop, detailed in FIG. 18. It then triggers an LED on the docking station to blink (step 1801, FIG. 18), indicating that the UART and SPI interfaces have been initialized.

According to some example embodiments, the UART communication between the card control unit and the programming software may be encrypted. Before communication over UART commences the card has a predetermined AES256 key for decrypting data sent by the terminal (computer). This key may be generated by applying a MD5 hash onto the card ID and picking up a fixed number of characters from particular known locations of the MD5 hash. The same key may be generated by the user software when it queries the card for the card ID (step 1808, FIG. 18).

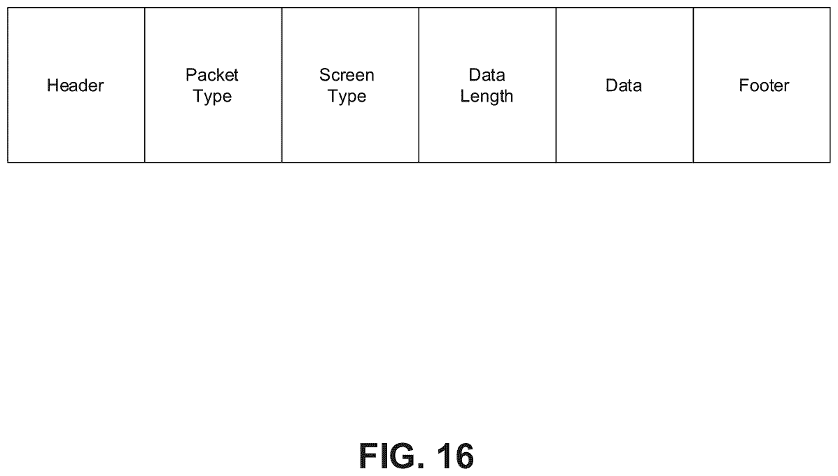

FIG. 16 is a schematic representation of the information packet format exchanges between the programming software and the card's control unit.

According to some example embodiments, the information packet may include a header. The information packet may also include a packet type, wherein the packet type may be a configuration packet, an ID packet, a password packet or a data packet. The information packet may also include a screen type, wherein the screen type may be a color screen or a greyscale screen. The information packet may include the data length and the data. Finally, the information packet may include a footer.

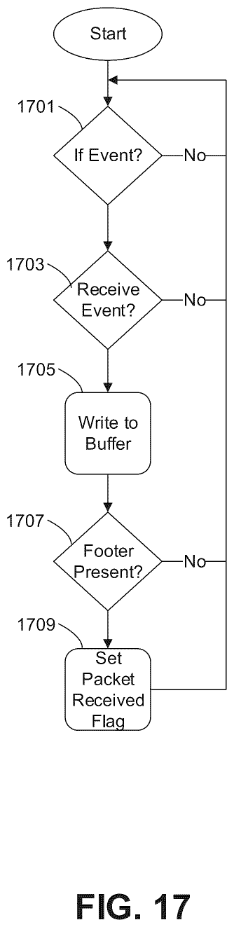

FIG. 17 is a flow diagram detailing the method of transmitting the information packets from the programming software to the card's control unit.

At step 1701, the control unit evaluates if an event is occurring, wherein an event may be packets or bytes being received by the UART internal buffer. If it is not, the method moves back to the start. If it is, the method advances to step 1703.

At step 1703, the control unit assesses whether a receive event is occurring, wherein a receive event occurs when the data received reaches a predetermines sequence of bytes. If it does not, the method moves back to the start. If it does, the method advances to step 1707.

At step 1705, the information packet may be transferred from the UART internal buffer to the control unit's RAM buffer.

At step 1707, the control unit evaluates if a footer is present in the information packet. If it is not, the method moves back to the start. If it is, the method advances to step 1709.

At step 1709, the control unit sets a packet received flag, wherein the flag may be monitored by the main loop detailed in FIG. 18.

FIG. 18 is a flow diagram of the method followed by the control unit after the card has been connected to the programing software through the docking station.

At step 1801, an LED blinks on the card, indicating that the UART and SPI interfaces have been initialized.

At step 1802, the control unit evaluates whether an information packet has been received, wherein a packet received flag may be set by the control unit when an information packet has been received (step 1709, FIG. 17). If no packet has been received, the method moves back to the start. If a packet has been received and a received packet flag has been set, the method advances to step 1803.

At step 1803, the control unit checks whether the packet header is corrupted, meaning that the information packet is not valid. If the header is corrupted, the method moves back to the start. If it is not, the method advances to step 1804.

At step 1804, the control unit evaluates if the packet is a configuration query packet. A configuration query packet indicates that the programming software is requesting the configuration details of the access card. If it is, the method moves to step 1805. If it is not, the method advances to step 1807.

At step 1805, the control unit sends a configuration packet to the programming software. The method subsequently advances to step 1806.

In some example embodiments, the configuration packet may indicate if the card has one or two screens. The configuration packet may also indicate if the screen or screens are color screens or greyscale screens.

At step 1806, the control unit clears the message buffer, deleting the packet received flag, and the method goes back to the start.

At step 1807, the control unit evaluates if the packet is an ID query packet. If it is, the method advances to step 1808. If it is not, the method moves to step 1809.

At step 1808, the control unit sends the card's ID to the programming software. And generates an encryption key to decrypt the encrypted data sent by the programming software. The method subsequently moves to step 1806 and then moves back to the start.

At step 1809, the control unit evaluates if the packet is a password packet. A password packet contains a password shared between the control unit and the programming software to assess whether the programming software is allowed to program the access card. If it is a password packet, the method moves to step 1810. If it is not, the method advances to step 1812.

At step 1810, the control unit verifies if the password shared by the programming software is correct. If it is not, the programming software cannot program the access card, the method moves to step 1806 and subsequently moves back to the start of the method. If the password is correct, the method advances to step 1811.

At step 1811, the control unit sets a “Password okay flag” and the method moves to step 1806.

At step 1812, the control unit evaluates if the packet is a data packet. If it is, the method moves to step 1813. If it is not, the control unit does not recognize the type of packet that was sent, the method moves to step 1806 and subsequently moves back to the start.

According to some example embodiments, the data packet may include picture data. In such embodiments, the picture is previously converted into a single array by the programming software, which is x*y bytes long where x is the width of the image and y is the height of the image. This array is then cut into packets of 5000 bytes each, the last packets may be less than 5000 bytes depending on number of pixels.

At step 1813, the control unit evaluates if the password exchange has been completed, and if a “Password okay flag” has been set (step 1811). If it has not, the method moves to step 1806 and subsequently moves back to the start. If it has, the method advances to step 1814.

At step 1814, the control unit tries to decrypt the encrypted data packet using the encryption key generated at step 1808. If the encryption key is not correct and the control unit cannot decrypt the data packet, the method moves to step 1815. If the control unit can decrypt the data packet, the method proceeds to step 1816.

At step 1815, the control unit sends a “Decrypt Fail” message to the programming software.

At step 1816, the control unit checks if the packet format (FIG. 16) is correct. Due to high-speed UART communication, errors in data transmission may occur, and a data packet may not be complete. If it is not, the method moves to step 1817. If it is the method advances to step 1818.

At step 1817, the control unit sends a “Parse Fail” message to the programming software alongside a request to send to data packet again.

At step 1818, the control unit displays the data received in the data packet on the screen and requests the next data packet. The data may be written to the screen in real time. This method is faster compared to caching the whole data in flash and then programming the screen as the main overhead is in data transmission in UART communications.

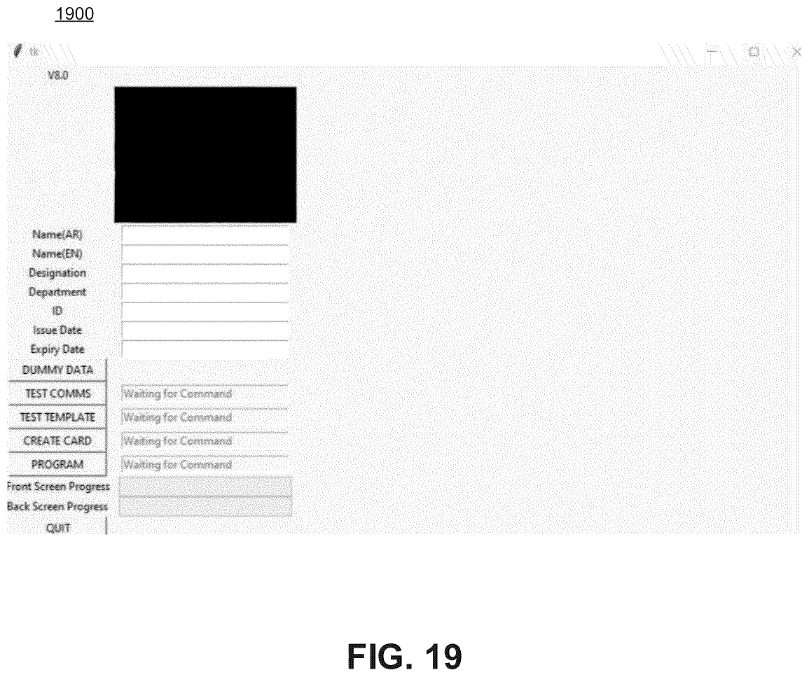

FIG. 19 is an example of the programming software interface 1900. In accordance with some exemplary embodiments, the interface 1900 of the programming software may display a template of the information displayed on the card according to the layout and appearance of a card that may be used at the location.

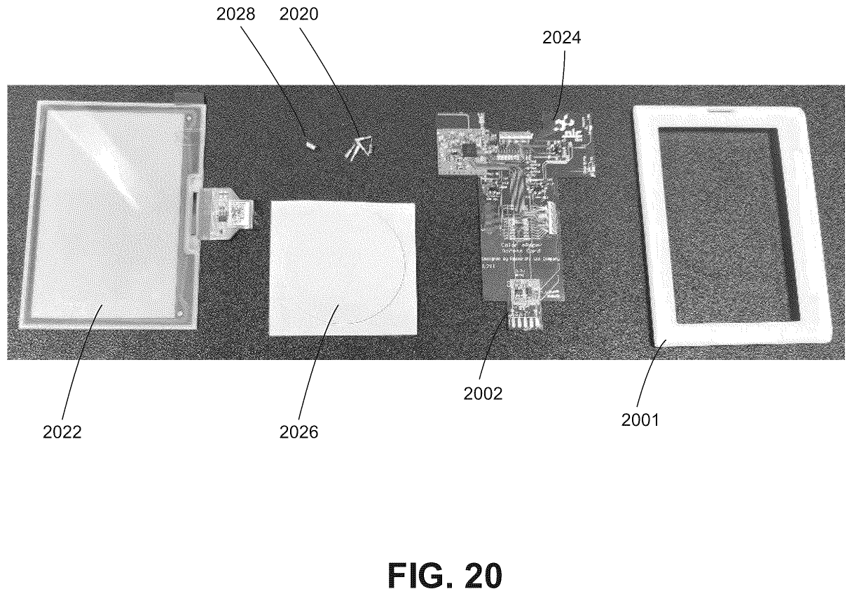

FIG. 20 is a picture of the common components of the access card. The components may include at least one screen 2022 (e.g., greyscale screen or color screen), an NFC or RFID chip 2026, pins 2020 (e.g., gold plated pins), a PCB 2024 where the components of the cards are mounted, including a UART TTL Connector 2002, an enclosure 2001, and at least one magnet 2028.

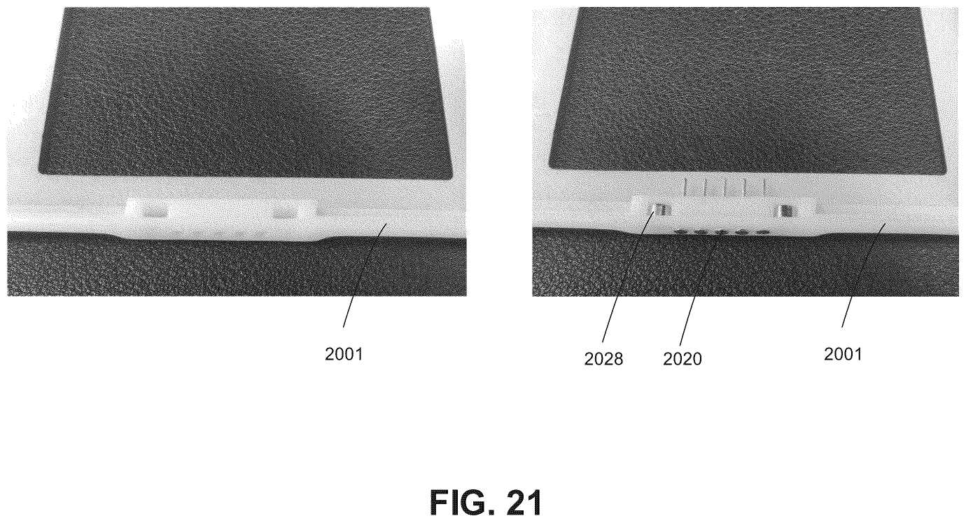

FIG. 21 is a picture of the enclosure 2001 with pinholes, magnets 2028, and mounted pins 2020.

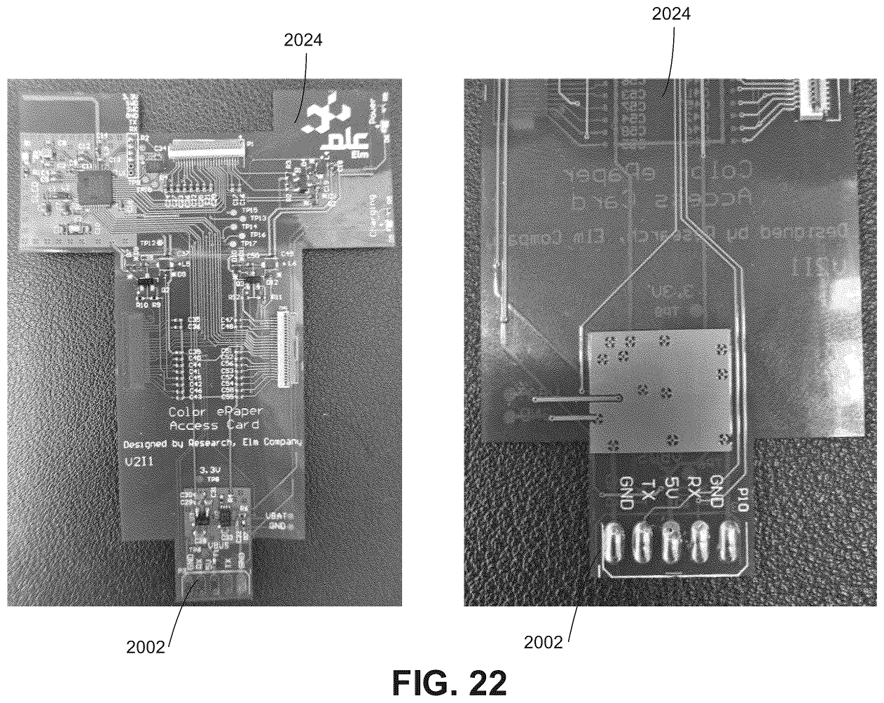

FIG. 22 is a picture of PCB 2024 where the components of the cards are mounted. According to some example embodiments, the manufacturing process of PCB 2024 may include a unique PCB board compatible with all the possible example embodiments. For example, PBC 2024 may comprise 4 screen connectors, 2 connectors adapted to a greyscale display and 2 connectors adapted to a color display. At the assembling stage of the access card, one can choose what display to connect. PCB 2024 may, for example, include UART TTL Connector 2002.

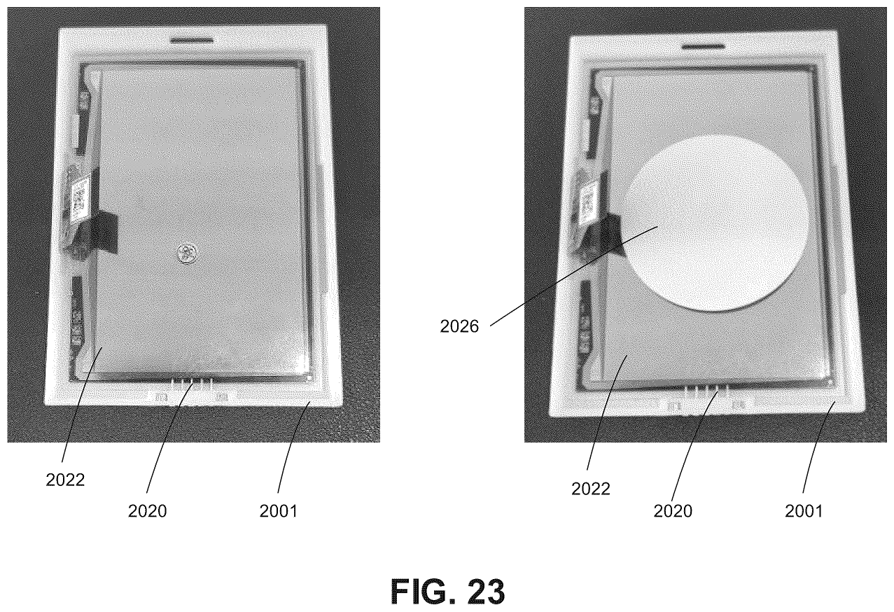

FIG. 23 is a picture of screen 2022 being mounted to enclosure's 2001 front section, and a NFC or RFID chip 2026 being stuck to screen 2022. Pins 2020 mounted on enclosure 2001 are also shown.

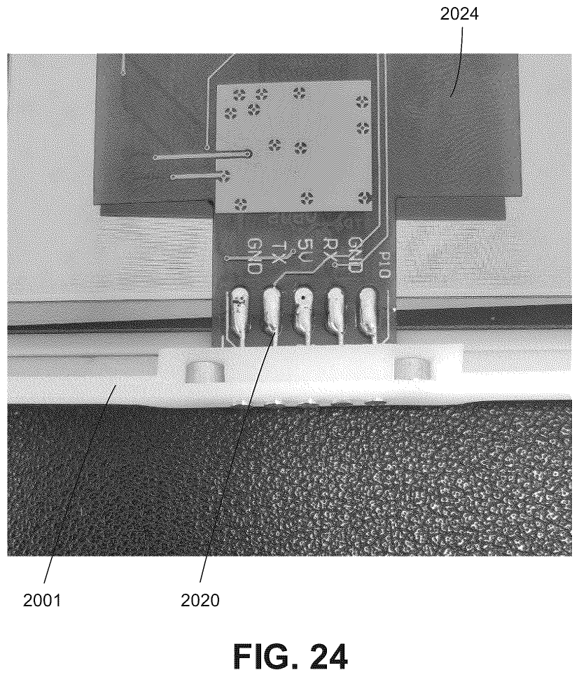

FIG. 24 is a picture of the PCB 2024 pads aligned with pins 2020 and soldered.

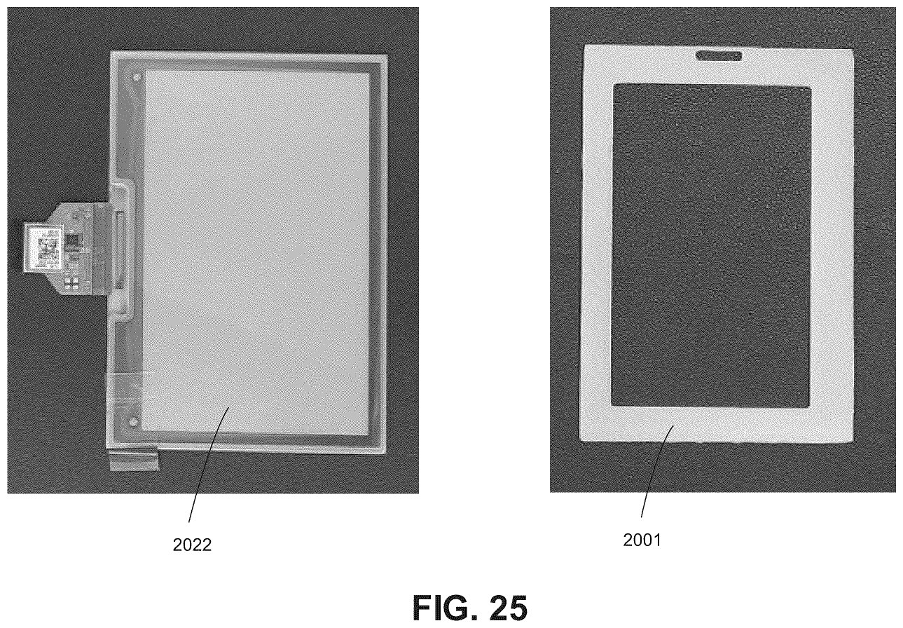

FIG. 25 is a picture of color screen 2022 and back plate (e.g., part of enclosure 2001) of a card having two screens.

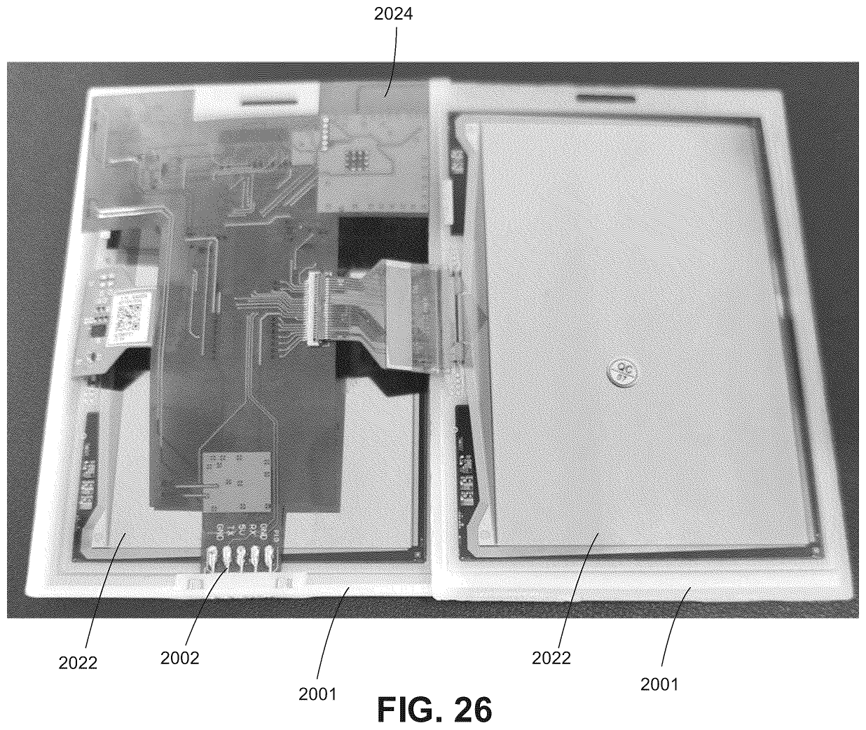

FIG. 26 is a picture of a card with two screens 2022 being assembled. During assembly of the card, PCB 2024 may be connected to screens 2022 and pins 2002, and place into enclosure 2001.

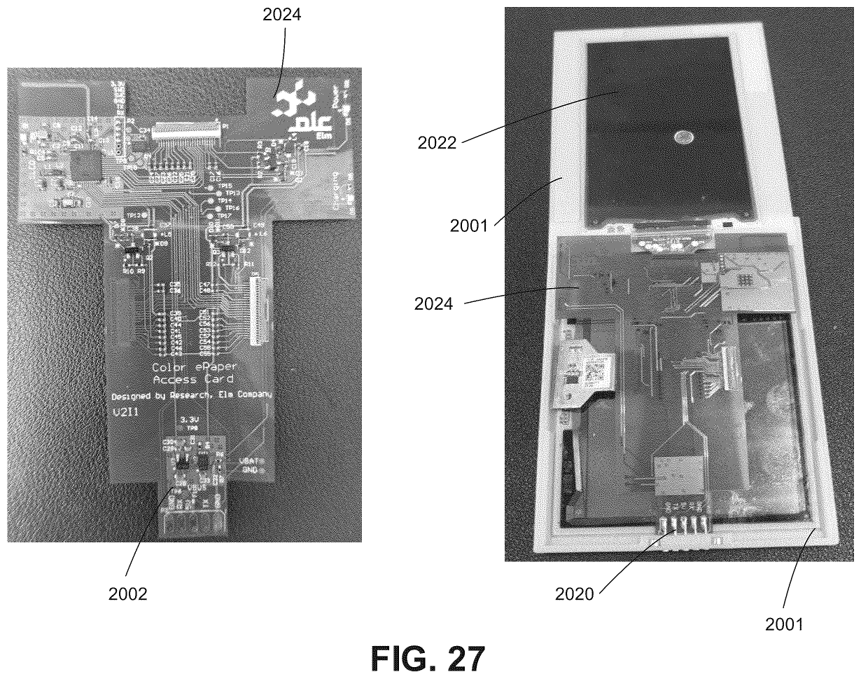

FIG. 27 is a picture of a greyscale screen 2022 being connected to a screen connector (e.g., on PCB 2024), and mounted in the card's enclosure 2001, and pins 2020 being connected to PCB 2024 via UART TTL Connector 2002.

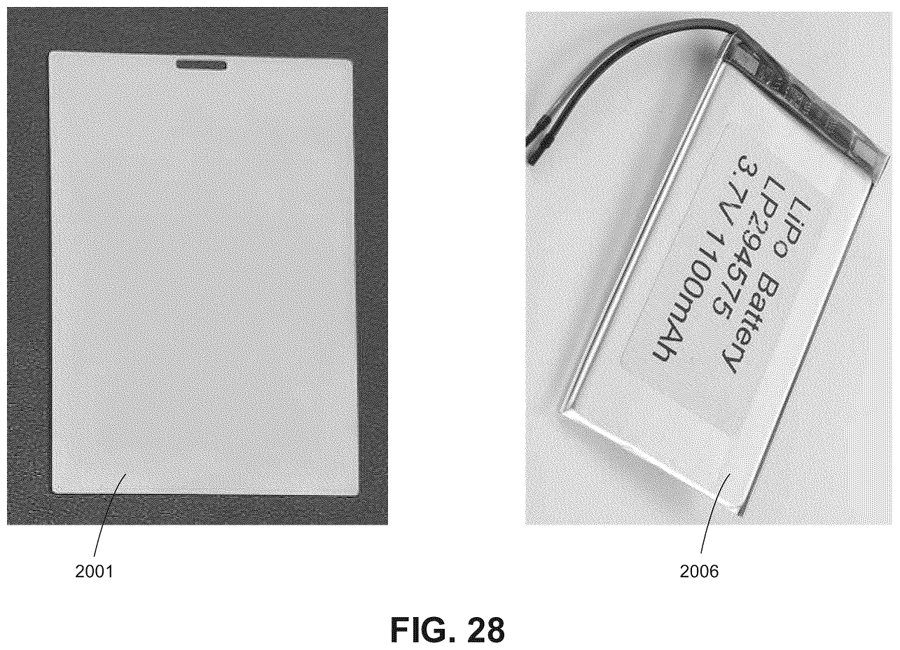

FIG. 28 is a picture of the back of a card (e.g., part of enclosure 2001) having only one screen, and a picture of an ultrathin battery 2006.

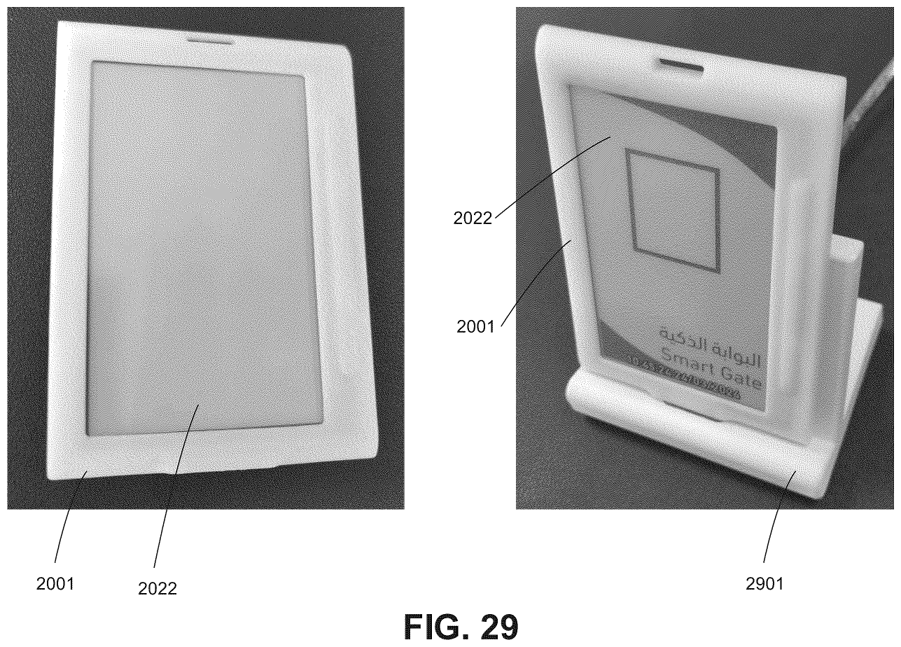

FIG. 29 is a picture of a card after complete assembly showing screen 2022 and enclosure 2001, and a picture of the card, showing screen 2022 and enclosure 2001, on the docking station 2901.

Disclosed embodiments may include any one of the following bullet-pointed features alone or in combination with one or more other bullet-pointed features, whether implemented as a device, system, apparatus, and/or method:
an access card for accessing a restricted location.
at least one display unit configured to display information even when the display unit is unpowered.
a control unit powered by a power source.
a control unit configured to vary the information displayed on a display unit.
an I/O module enabling communication with a remote programming device.
a display unit comprising an electronic paper display.
a display unit may be a color display unit or a greyscale display unit.
a control unit comprising a processor.
a control unit comprising a timer.
a control unit configured to vary the information displayed on a display unit depending on a first predetermined condition being satisfied, wherein the first predetermined condition comprises expiry of a predetermined time period measured by the timer.
a wireless communication module.
a wireless communication module that enables a terminal to wirelessly communicate with the access card
a control unit that is triggered to vary the information displayed on the at least one display unit based on wireless communication with the terminal.
a wireless communication module that comprises an NFC or RFID chip configured to communicate with an NFC or FRID terminal controlling access to the restricted location.
a control unit that is configured to disable the NFC or RFID chip depending on a second predetermined condition being satisfied.
a second predetermined condition that is the same as the first predetermined condition.
a first predetermined condition comprises expiry of a predetermined time period for accessing the restricted location.
a first predetermined condition comprises a change in access rights of a user.
a tracking device configured to indicate a location of the access card.
a tracking device that comprises a Bluetooth Low Emission module configured to communicate with one or more fixed remotely located Bluetooth gateways.
an audio unit configured to emit an audible signal when the access card is located in a location it is not authorized to be in.
information displayed on the card includes at least one of the following: a name of a card user, a picture of a card user, names, numbers, denominations or representations of locations a user of the access card is authorized to access.
information displayed on the card includes a QR code.

The foregoing description is presented for purposes of illustration. It is not exhaustive and is not limited to precise forms or embodiments disclosed. Modifications and adaptations of the embodiments will be apparent from consideration of the specification and practice of the disclosed embodiments. While certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of this disclosure are apparent from this detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Throughout this application, various embodiments of the present disclosure may be presented in a range format. It should be understood that the description in range format is merely for convenience and brevity and should not be construed as an inflexible limitation on the scope of the present disclosure. Accordingly, the description of a range should be considered to have specifically disclosed all the possible subranges as well as individual numeric values within that range. For example, description of a range such as from 1 to 6 should be considered to include subranges such as from 1 to 3, from 1 to 4, from 1 to 5, from 2 to 4, from 2 to 6, from 3 to 6, and so forth, as well as individual numbers within that range, for example, 1, 2, 3, 4, 5, and 6. This applies regardless of the breadth of the range.

Other embodiments will be apparent from consideration of the specification and practice of the embodiments disclosed herein. It is intended that the specification and examples be considered as example only, with a true scope and spirit of the disclosed embodiments being indicated by the following claims.

1. An access card for accessing a restricted location, the access card comprising:
at least one display unit configured to display information even when the display unit is unpowered; and
a control unit powered by a power source, the control unit being configured to vary the information displayed on the at least one display unit depending on a first predetermined condition being satisfied.

2. The access card of claim 1, wherein the access card comprises an I/O module enabling communication with a remote programming device.

3. The access card of claim 1, wherein the at least one display unit comprises an electronic paper display.

4. The access card of claim 1, wherein the display unit may be a color display unit or a greyscale display unit.

5. The access card of claim 1, wherein the control unit comprises a processor.

6. The access card of claim 1, wherein the control unit comprises a timer.

7. The access card of claim 6, wherein the first predetermined condition comprises expiry of a predetermined time period measured by the timer, and the control unit is configured to vary the information displayed on the at least one display unit on or after expiry of the predetermined time period.

8. The access card of claim 1, comprising a wireless communication module.

9. The access card of claim 8, wherein the wireless communication module enables a terminal to wirelessly communicate with the access card, and wherein the control unit is triggered to vary the information displayed on the at least one display unit based on wireless communication with the terminal.

10. The access card of claim 8, wherein the wireless communication module comprises an NFC or RFID chip configured to communicate with an NFC or FRID terminal controlling access to the restricted location.

11. The access card of claim 10, wherein the control unit is configured to disable the NFC or RFID chip depending on a second predetermined condition being satisfied.

12. The access card of claim 11, wherein the second predetermined condition and the first predetermined condition are the same.

13. The access card of claim 1, wherein the first predetermined condition comprises expiry of a predetermined time period for accessing the restricted location.

14. The access card of claim 1, wherein the first predetermined condition comprises a change in access rights of a user.

15. The access card of claim 1, comprising a tracking device configured to indicate a location of the access card.

16. The access card of claim 15, wherein the tracking device comprises a Bluetooth Low Energy module configured to communicate with one or more fixed remotely located Bluetooth gateways.

17. The access card of claim 16, wherein the access card comprises an audio unit configured to emit an audible signal when the access card is located in a location it is not authorized to be in.

18. The access card of claim 1, wherein the information displayed on the card includes a name of a card user.

19. The access card of claim 1, wherein the information displayed on the card includes a picture of a card user.

20. The access card of claim 1, wherein the information displayed on the card includes any one or more of: names, numbers, denominations or representations of locations a user of the access card is authorized to access.

21. The access card of claim 1, wherein the information displayed on the card includes a QR code.
